(19) United States
(12) Patent Application Publication
(10) Pub. No.: US 2002/0148124 A1
(43) Pub. Date: Oct. 17, 2002

(54) Sighting apparatus for engaging a trailer hitch

(76) Inventor: Carl Nicholas Strange, Flowery Branch, GA (US)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/837,054

(22) Filed: Apr. 17, 2001

(51) Int. Cl. G01C 15/00; B60Q 11/00

(52) U.S. Cl. 33/264; 33/286; 33/296; 33/DIG. 1; 116/28 R

(57) ABSTRACT

A tubular receiver is open at an upper end and integral with a flexible sheet magnet, suction cup or other attachment device, at a lower end. A rod is frictionally inserted into the tubular receiver and extends upwardly to terminate with a spherical shape. When one of these devices is fixed to hitch portions of a trailer and a towing vehicle, the driver of the vehicle is able, more easily, to bring the two hitch portions together.

### BACKGROUND OF THE INVENTION

1. Field of the Invention

This invention relates generally to guidance devices for engaging trailers to towing vehicles and more particularly to a vertically adjustable, magnetically engaged guidance device.

2. Description of Related Art

The following art defines the present state of this field:

Rahn, U.S. U.S. Pat. No. Design 342,226 describes a hitch guide.

Alexander et al., U.S. Pat. No. 3,866,328 describes a visual aid to assist a driver in maneuvering a vehicle having a first engagable portion of a trailer hitch on the rear part thereof to a position relative to a trailer having a second engaging portion of the trailer hitch on the forward part thereof so as to align the engagable and engaging portions in manner such that they can be removably engaged together, the visual aid guide device comprised of an extension member adapted to be fit on the bottom of the ball portion of the engagable portion mounted on the vehicle and having a pair of guide rods projecting longitudinally outwardly therefrom and spaced transversely apart with each guide rod having a vertically extending flag staff projecting upwardly therefrom into the line of vision of a driver looking through the rear window of the vehicle with the projecting ends of the rods adapted to engage the sides of a jack holding the socket engaging portion of the hitch of the trailer in an elevated position with the movement of the flag staff designating the direction in which the ball portion of the hitch must be moved in order to be properly aligned with the socket portion so as to properly aligned the same therebeneath in position for the socket portion to be dropped onto the ball portion to engage the same.

Metzler, U.S. Pat. No. 3,966,231 describes a device for the alignment of an automotive vehicle and a trailer. Also disclosed is a simple method of alignment for coupling of the automotive vehicle and trailer which utilizes two of the devices. The aligner device consists of a marking rod having attached at one end thereof and perpendicular to the longitudinal axis of said rod magnetic positioning means.

Christensen, U.S. Pat. No. 4,012,056 describes a guide device to assist the driver of a towing vehicle in properly positioning the hitch ball located on same for connection with the hitch socket of a trailer. A cover is closely fit over the hitch ball to mount a telescoping sight arm thereto. A compressible ball is tightly inserted in the socket to mount a second telescoping sight arm to the trailer hitch. The sight arms provide guides which enable the driver to accurately back a towing vehicle toward the trailer for connection of the cooperating hitch portions.

Paufler, U.S. Pat. No. 4,169,610 describes a trailer alignment device including a pair of clamps one provided for each of a ball hitch mounted to a vehicle and a trailer hitch on a vehicle to be towed. Each clamp includes arms for supporting a collapsible vertically extendable rod such that the rods are aligned directly over the ball and hitch respectively. A sighting chain is provided at the end of each rod to assure vertical orientation of the rod. Such structure permits the clamps to be readily attached so that a vehicle can be backed into alignment with a trailer with the ball in alignment under the corresponding hitch when the pair of vertical rods contact one another.

Gunn et al., WO90/14968 describes a docking aid for use in lining up a vehicle to a trailer comprising a first rod attached to the vehicle which is aligned with a second rod attached to the trailer so that the vehicle can be positioned correctly for hitching the trailer so that the vehicle can be positioned correctly for hitching the trailer to the vehicle. A further method of providing attachment means is to use a galvanised plate which is positioned about or underneath the towball, and which has connective means for the housing means or has the housing means as an integral part of the plate. Markings on the indicator means may also be provided to mark the heights of the ball and the hitch, and so enable correct spatial alignment between the two.

The prior art teaches the use of various guidance devices for reducing the problems in joining a trailed vehicle to a towing vehicle, but does not teach the use of a flexible magnetic sheet attachment device for gripping the guidance device to non-planar surfaces. The present invention fulfills these needs and provides further related advantages as described in the following summary.

### SUMMARY OF THE INVENTION

The present invention teaches certain benefits in construction and use which give rise to the objectives described below.

A tubular receiver is open at an upper end and integral with a flexible sheet magnet, suction cup or other attachment device, at a lower end. A rod is frictionally inserted into the tubular receiver and extends upwardly to terminate with a spherical shape. When one of these devices is fixed to hitch portions of a trailer and a towing vehicle, the driver of the vehicle is able, more easily, to bring the two hitch portions together.

A primary objective of the present invention is to provide an apparatus and method of use of such apparatus that provides advantages not taught by the prior art.

Another objective is to provide such an invention capable of simple and inexpensive construction.

A further objective is to provide such an invention capable of flexibly engaging variously shaped hitch parts and to be immediately removed without tools or time consuming fastening and unfastening.

A still further objective is to provide such an invention capable of vertical height adjustment to function properly with a range of vehicles.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIGS. 1 and 2 are side elevational views of the present invention in one embodiment, showing how a flexible magnetic sheet of the invention is able to accommodate non-planar surfaces;

FIG. 3 is a perspective view thereof.

FIG. 4 is a further similar view thereof showing one use of the invention; and

FIG. 5 is a side elevational view of an alternate embodiment thereof.

### DETAILED DESCRIPTION OF THE INVENTION

The above described drawing figures illustrate the invention in at least one of its preferred embodiments, which is further defined in detail in the following description.

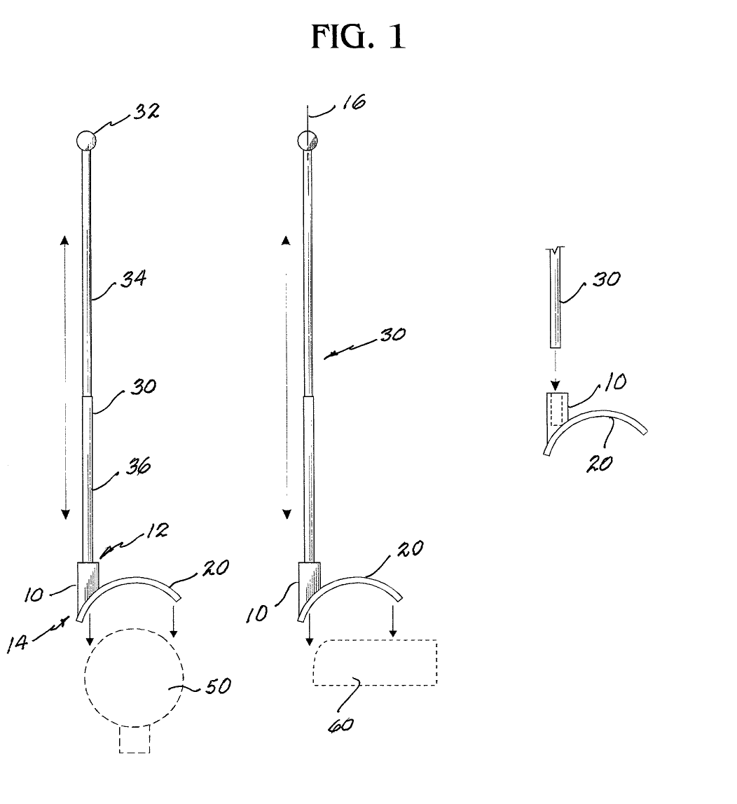

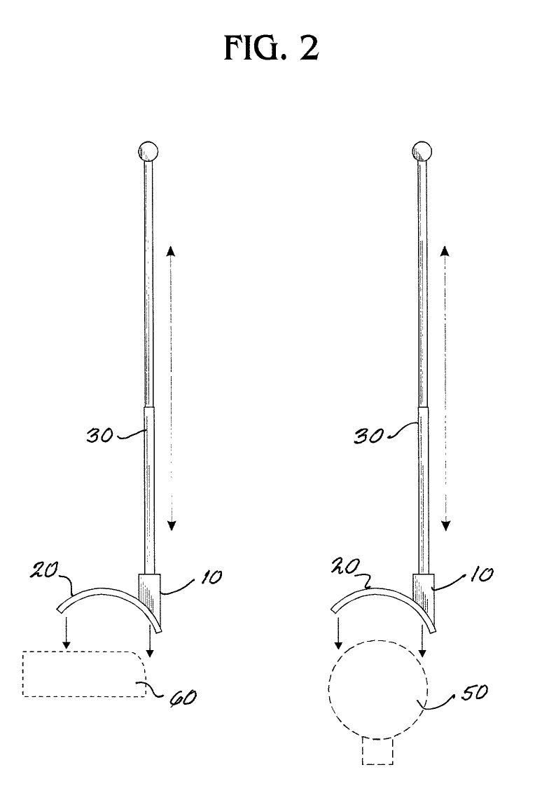

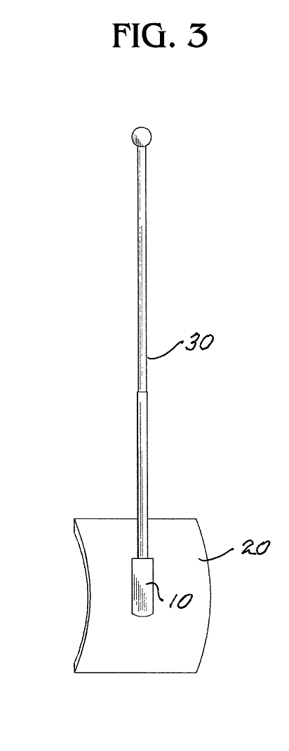

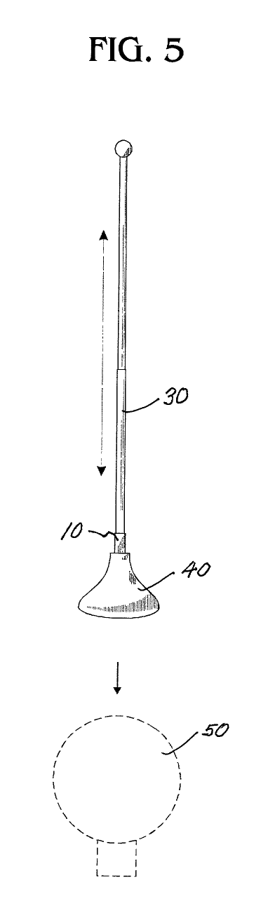

The invention apparatus comprises a tubular receiver 10, open at an upper end 12 and integral with a flexible sheet magnet 20 at a lower end 14. The receiver 10 is preferably made of a hard and rigid material such as metal or plastic. The flexible sheet magnet 20 is made in a manner similar to the well known refrigerator magnet and is preferably highly flexible and yet magnetically strong. Such flexibility is able to accommodate the shapes shown in FIGS. 1 and 2. A rod 30, also of metal or plastic with a light reflecting surface finish or coating, and, is frictionally inserted into the tubular receiver 10 so as to be semi-permanently or permanently engaged therewith, and extends upwardly, when in use, to terminate with a spherical or other distinctive shape 32. Shape 32 must be large enough to see clearly at a distance of from 10-40 feet when in use. The rod is preferably comprised of telescoping steel segments 34, 36 for vertical length adjustment as with automotive radio antennas. Preferably, the intersection of the tubular receiver 10 and the sheet magnet 20 is not normal to a longitudinal axis 16 of the tubular receiver 10. This is to further accommodate the non-planar surface to which the magnetic sheet must be attached. In place of the sheet magnet 20 a suction cup 40 may be fastened at a lower end of the tubular receiver 10 and this is best used for engagement with a hitch ball or stainless steel trailer. In this case, the rod 30 is frictionally inserted into the tubular receiver 10 and extends upwardly as in the above manner, as shown in FIG. 5.

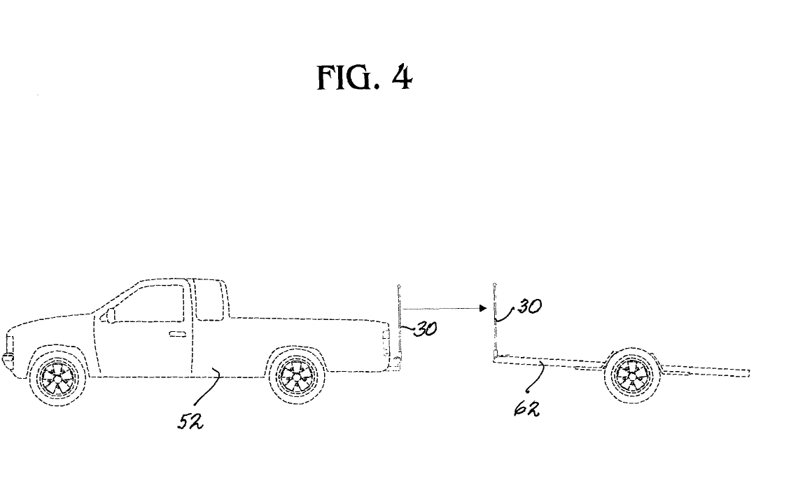

The inventive apparatus may also be comprised of a pair of the tubular receivers 10, as shown in FIG. 4, each open at an upper end 12 and each integral with a flexible sheet magnet 20 or suction cup 40 at a lower end 14. A pair of rods 30 are, each frictionally inserted into one of the tubular receivers 10 and each extends upwardly therefrom to terminate with the distinctive shape 32. In this case, with one of the flexible sheet magnets 20 magnetically engaged with a hitch ball 50 of a towing vehicle 52 and the other of the flexible sheet magnets 20 magnetically engaged with a trailer hitch 60 of a towed vehicle 62 the respective rods are positioned vertically and within sight of a driver in the vehicle so as to enable coupling of the trailer hitch with the hitch ball, both of which are not within sight of the driver, as shown in FIG. 4.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. An apparatus comprising: a tubular receiver open at an upper end thereof and integral with a flexible sheet magnet at a lower end; a rod frictionally inserted into the tubular receiver and extending upwardly therefrom to terminate with a spherical shape.

2. The apparatus of claim 1 wherein the rod is comprised of telescoping segments for vertical length adjustment thereof.

3. The apparatus of claim 1 wherein the intersection of the tubular receiver and the sheet magnet is not normal to a longitudinal axis of the tubular receiver.

4. An apparatus comprising: a tubular receiver open at an upper end thereof and integral with a suction cup at a lower end; a rod frictionally inserted into the tubular receiver and extending upwardly therefrom to terminate with a spherical shape.

5. The apparatus of claim 1 wherein the rod is comprised of telescoping segments for vertical length adjustment thereof.

6. An apparatus comprising: a pair of tubular receivers each open at an upper end thereof and each integral with a flexible sheet magnet at a lower end; a pair of rods, each frictionally inserted into one of the tubular receivers and each extending upwardly therefrom to terminate with a spherical shape; wherein with one of the flexible sheet magnets magnetically engaged with a hitch ball of a towing vehicle and the other of the flexible sheet magnets magnetically engaged with a trailer hitch of a towed vehicle such that the respective rods extend upwardly, coupling of the trailer hitch with the hitch ball is improved.
